(19) United States
(12) Patent Application Publication
(10) Pub. No.: US 2006/0118466 A1
(43) Pub. Date: Jun. 8, 2006

(54) Two-step method for hydrotreating of a hydrocarbon feedstock comprising intermediate fractionation by rectification stripping

(76) Inventors: Renaud Galeazzi, Paris (FR); Denis Jean Marie Guillaume, Vienne (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/496,567

(22) PCT Filed: Nov. 22, 2001
(86) PCT No.: PCT/FR01/03684

§ 371 Date: Jul. 20, 2005

(51) Int. Cl. C10G 65/04; B01J 8/04

(52) U.S. Cl. 208/210; 208/212; 422/188

(57) ABSTRACT

A process for hydrotreatment of a hydrocarbon feed comprises at least two reaction steps with intermediate fractionation of the effluent from the first step to eliminate unwanted impurities for the catalyst of the second step and to produce a desulphurized light liquid fraction. The intermediate fractionation comprises stripping the liquid effluent from the first step using low pressure hydrogen with rectification of the stripping vapours using a substantially desulphurized liquid reflux. The conditions for said fractionation and for the first hydrotreatment step can produce a substantially desulphurized light liquid fraction which is not supplied to the second step.

The present invention relates to hydrotreatment of hydrocarbon fractions, for example gasoline or middle distillates, to produce hydrocarbon fractions with a low sulphur content, low nitrogen content and possibly low aromatic compound content, particularly for use in the field of internal combustion engine fuels. Such hydrocarbon fractions include jet fuel, diesel fuel (or gas oil), kerosene, vacuum distillate and deasphalted oil. The invention can carry out deep desulphurization of petroleum feeds, in particular middle distillates, in a cost-effective manner.

Currently, middle distillate type cuts from straight run distillation of a crude oil or from a catalytic cracking process still contain non negligible quantities of aromatic compounds, nitrogen-containing compounds and sulphur-containing compounds. Current legislation in many industrialized states requires that fuel for use in diesel engines must contain less than about 500 parts per million (ppm) of sulphur, and that specification must soon be reduced to 50 ppm and very probably will in the medium term be further reduced to 10 ppm or even less. Currently, the aromatics content of a diesel fuel is not regulated, but in some cases the amount of aromatics in base cuts must be limited in order to satisfy cetane index specifications.

Thus, changes in specifications render necessary the development of a reliable, efficient process for producing, from conventional straight run middle distillates or from catalytic cracking (LCO cuts) or from another conversion process (cokefaction, visbreaking, residue hydroconversion, etc), a product with improved characteristics both as regards the cetane index and as regards the aromatics or nitrogen content, and in particular the sulphur content.

The present invention concerns a high performance hydrotreatment process that can in particular be used to treat difficult feeds of mediocre quality to produce high quality fuels. It comprises at least two reaction steps with intermediate fractionation of the effluent from the first step in a pressurized hydrogen stripping column to eliminate impurities that are undesirable for the catalyst in the second step, and to produce a substantially desulphurized light liquid fraction which is not supplied to the second step. Intermediate fractionation comprises stripping the liquid effluent from the first step using pressurized hydrogen and rectification of the stripping vapours by means of a substantially desulphurized liquid reflux.

This process results in a very low pollutant content in the second step, in particular in H₂S and water, and means that a catalyst based on a noble metal or comprising a noble metal can be used in the second step under the best service conditions for that catalyst. It also means that a smaller reactor can be used in the second step, thus reducing the costs of the unit and increasing the energy efficiency.

The present invention also concerns a substantially desulphurized hydrocarbon fraction that is possibly partially dearomatized obtained using the process of the invention, and any hydrocarbon cut or fuel containing said fraction.

Definitions and Conventions used in the Invention

The present description of the invention will use the following notations, definitions and conventions:
ppm for parts per million, expressed by weight;
conventionally, the pressure of a reaction step is the pressure at the outlet from the reactor (or last reactor) of that step. Conventionally, the pressure of a hydrogen-rich recycle loop is the pressure at the intake of the recycle compressor;
the term “purity” as applied to a hydrogen-containing gas and designated “Pur” means a molar percentage of molecular hydrogen: as an example, a purity Purl of 85 for a gas means that the gas contains 85 mole % of hydrogen (molecular). Conventionally, a “hydrogen-rich gas” or “hydrogen” is a gas with a molecular hydrogen purity of more than about 50. Conventionally, the purity of a hydrogen-rich recycle gas (or purity of the gas in that loop) is the purity of the gas at the intake of the recycle compressor for that loop;
the term “recycle loop” or “hydrogen recycle loop” is applied to recycling a hydrogen-rich gas to a hydrotreatment reactor after downstream gas/liquid separation and compression of the gas (or a portion of the gas) to allow recycling. By extension, a “recycle loop” also comprises the lines and equipment traversed by a recycle gas, possibly mixed with a liquid phase (such as the feed). In particular, a recycle loop comprises at least one recycle compressor, a hydrotreatment reactor, a gas/liquid separation drum downstream of the reactor and/or optionally, the portion of the pressurized hydrogen stripping column located above the supply, if that column is located on the recycle gas circuit: thus, a recycle loop comprises the lines and equipment located on the path of the recycle gas; it can thus also comprise branches and bypasses: as an example, a portion of the compressed gas can be removed from the stream of recycle gas upstream of the reactor and supply the reactor at an intermediate portion for use as a quench gas and/or to supply the stripping column (as the stripping gas). The term “recycle loop” is thus used to qualify a closed circuit that can comprise, downstream of the recycle compressor, branches and parallel portions of the circuit, following the gas path, said portions generally joining together upstream of the recycle compressor or compressors for that loop;
the feed for the process of the invention designates a liquid stream of hydrocarbons supplying a hydrotreatment zone and also a liquid stream recovered downstream of said hydrotreatment zone which can, for example, be termed a partially desulphurized feed, even if that partially desulphurized feed is chemically different from the initial feed primarily because sulphur has been eliminated from certain compounds, and also because of saturation of a portion of the aromatics and elimination of a fraction of that feed because of the formation of light gaseous products in the reaction steps which are not recovered in liquid form;
the term “hydrotreatment” relating to the process of the invention is applicable to processing a hydrocarbon feed under hydrogen pressure, the total pressure being in the range from about 2 to about 20 MPa, and usually between about 3 and about 18 MPa to carry out one or more chemical reactions from the group constituted by the following reactions: hydro-desulphurization, hydro-denitrogenation, hydro-demetallization (to eliminate one or more metals such as vanadium, nickel, iron, sodium, titanium, silicon, copper), and hydrodearomatization;
the term “cut point” applied to fractionation (depending on the boiling point) of a petroleum cut (thus real and not ideal fractionation) is the boiling point of a compound located at the limit between the light fraction and the heavy fraction in an ideal fractionation (infinite number of theoretical plates, infinite reflux ratio), ideal fractionation giving the same proportion of light fraction and the same proportion of heavy fraction as real fractionation.

### PRIOR ART

Hydrotreatment processes carried out in at least two steps are already known wherein the first step is generally a desulphurization step and the second step (or last step) is either a deep desulphurization step or a dearomatization step, or a combination of desulphurization and dearomatization; each step can comprise one or more reactors, one or more catalytic zones (or beds), and can use identical or different catalysts.

The catalysts used for hydrotreatment (hydrodesulphurization and/or hydrodemetallization, and/or hydrogenation, in particular of aromatics, and/or hydrodearomatization) generally comprise a porous mineral support, at least one metal or metal compound from group VIII of the periodic table (said group comprising cobalt, nickel, iron, rhodium, palladium, platinum, etc) and at least one metal or compound of a metal from group VIB of the periodic table (said group comprising molybdenum, tungsten, etc).

The sum of the metals or metallic compounds, expressed as the weight of metal with respect to the weight of finished catalyst, is usually in the range 0.5 to 45% by weight.

The sum of metals or compounds of metals from group VIII, expressed as the weight of metal with respect to the weight of finished catalyst, is usually in the range 0.5% to 15% by weight.

The sum of metals or compounds of metals from group VIB, expressed as the weight of metal with respect to the weight of finished catalyst, is usually in the range 2% to 30% by weight.

In a non-limiting manner, the mineral support can comprise one of the following compounds: alumina, silica, zirconia, titanium oxide, magnesia, or two compounds selected from the preceding compounds, for example silica-alumina or alumina-zirconium, or alumina-titanium oxide, or alumina-magnesia, or even three or more compounds selected from the preceding compounds, for example silica-alumina-zirconium or silica-alumina-magnesia.

The support can also either partially or completely comprise a zeolite.

A frequently used support is alumina, or a support composed principally of alumina (for example 80% to 100% of alumina); said support can also comprise one or more other elements or promoter compounds based, for example, on phosphorus, magnesium, boron, silicon, or comprising a halogen. As an example, the support can comprise 0.01% to 20% by weight of B₂O₃, or SiO₂, or P₂O₅, or a halogen (for example chlorine or fluorine), or 0.01% to 20% by weight of a combination of a plurality of these promoters.

Examples of routinely used catalysts are catalysts based on cobalt and molybdenum, or on nickel and molybdenum, or on nickel and tungsten, on an alumina support; said support can comprise one or more promoters such as those cited above.

Frequently, other catalysts comprising at least one noble metal or a compound of a noble metal are used, said noble metal usually being rhodium, palladium or platinum, and usually palladium or platinum (or a mixture of said elements, for example palladium and platinum).

The quantity of noble metal or noble metals in such catalysts is usually in the range 0.01% to about 10% by weight with respect to the finished catalyst.

Such noble metal type catalysts are generally more efficient than conventional catalysts, in particular for hydrogenation, and allow lower temperatures to be used with lower catalytic volumes. However, they are more expensive and more sensitive to impurities.

The operating conditions for hydrotreatment are well known to the skilled person:

The temperature is typically in the range about 200° C. to about 460° C.

The total pressure is typically in the range from about 1 MPa to about 20 MPa, generally in the range 2 to 20 MPa, preferably in the range 2.5 to 18 MPa, and highly preferably in the range 3 to 18 MPa, usually in the range from about 4 to about 15 MPa.

The overall hourly space velocity of the liquid feed for each catalytic step is typically in the range from about 0.1 to about 12, and generally in the range from about 0.4 to about 10.

The hydrogen purity is typically in the range 50 to 100.

The quantity of hydrogen with respect to the liquid feed for each catalytic step is typically in the range from about 50 to about 1200 Nm³/m³ at the reactor outlet, and usually in the range from about 100 to about 1000 Nm³/m³ at the reactor outlet.

The process of the invention is not bound to a particular hydrotreatment catalyst or to particular operating conditions, but can be used with any hydrotreatment catalyst (or catalysts) and to any operating conditions for hydrotreatment that are already known to the skilled person and which could be developed in the future.

Other elements linked to the operating conditions, to the gas purification techniques, and to the catalysts used in hydrotreatment can be found in published documents and patents, and in particular but not in a limiting manner to the documents or patents cited in the present description, in particular in European patent application EP-A-0 1 063 275, pages 5 and 6.

In order to carry out the invention, and for each hydrotreatment reactor, the skilled person could employ one or more catalysts and the operating conditions disclosed in the prior art documents, in particular those summarized in the present application, or novel catalysts and novel hydrotreatment conditions which may be developed in the future.

United States patent U.S. Pat. No. 6,217,748 describes a two-step process for desulphurization of a diesel cut with intermediate distillation, to separate a light fraction and a heavy fraction, the cut point between said two fractions being in the range 320° C. to 340° C.

That process can extract the light fraction prior to the second reaction step and thus reduces the reactor size in that section. However, intermediate distillation causes high energy consumption. Further, such distillation cannot be envisaged at diesel cut hydrotreatment step pressures (generally more than about 4 MPa), as this would result in excessive column bottom temperatures, usually exceeding the cracking onset temperature, typically about 400° C. The distillation pressure is not specified in the patent cited above, however the examples use atmospheric pressure or normal conditions. Thus, that process can be considered to use a moderate distillation pressure close to atmospheric pressure, a pressure used in refining to fractionate diesel type cuts in “atmospheric” distillation typically operated at a pressure of less than 0.5 MPa. Thus, that process requires a pump with a high differential pressure to feed the second reaction step.

The flowchart for that process shows a concatenation of two successive hydrotreatment units with intermediate fractionation and nbt an integrated process. Typically, this leads to cooling of the effluent from the first unit (conventionally to about 50° C. by feed/effluent exchange) then reheating the effluent for the intermediate distillation then the second downstream hydrotreatment unit, which requires very large exchange surfaces.

Further, patents are known which concern hydrotreatment processes in two or more steps integrated with intermediate stripping using high pressure hydrogen, stripping resulting in elimination of H₂S so that the second reaction step operates under conditions that favour a relatively low H₂S content:

U.S. Pat. No. 5,114,562 describes a process for hydrotreatment of a middle distillate in at least two consecutive steps to produce desulphurized and dearomatized hydrocarbon cuts comprising a first hydrodesulphurization step the effluent from which is sent to a hydrogen stripping zone, to eliminate the hydrogen sulphide it contains. The desulphurized fraction obtained is sent to a second reaction zone, in particular hydrogenation, comprising at least two reactors in series, in which the aromatic compounds are hydrogenated. The stripping zone does not include a reflux.

U.S. Pat. No. 5,110,444 describes a process comprising hydrotreatment of a middle distillate in at least three distinct steps. The effluent from the first hydrodesulphurization step is sent to a hydrogen stripping zone to eliminate the hydrogen sulphide it contains. The desulphurized liquid fraction obtained is sent to a first hydrogenation zone the effluent from which is sent to a second stripping zone distinct from the first. Finally, the liquid portion from the second stripping zone is sent to a second hydrogenation zone. The stripping zone does not include a reflux.

European patent application EP-A-1 063 275 describes a process for hydrotreatment of a hydrocarbon feed comprising a hydrodesulphurization step, a step in which the partially desulphurized effluent is sent to a hydrogen stripping zone then to a hydrotreatment step to obtain a partially dearomatized and substantially desulphurized effluent. In that process, the gaseous effluent from the stripping step is cooled to a temperature sufficient to form a liquid fraction which is returned to the head of the stripping zone, to the same level as the principal supply, as it appears from the figures.

All of those hydrotreatment processes with intermediate pressurized hydrogen stripping have common elements: stripping is carried out with hydrogen (typically water-free or low in water); after stripping, hydrogen is recycled in the hydrogen loop, which results in stripping at high pressure (that of the hydrogen loop), and which does not substantially depressurize the liquid effluent from the first step prior to stripping. The two hydrotreatment steps are also highly integrated with a common or mixed hydrogen loop (mixture of hydrogen from the different circuits).

By comparison with the process of U.S. Pat. No. 6,217,748, those processes have several advantages: elimination of H₂S by hydrogen stripping consumes far less energy than distillation. Further, there is no need for a pump, or only a pump with a relatively small pressure differential, to transfer the stripped liquid and supply the second reaction step.

In contrast, they do have a drawback: all of the liquid feed leaving the first reaction step is supplied to the second step, which means that the size of the reactor for the second step cannot be reduced, as is the case with the unit in the process of U.S. Pat. No. 6,217,748.

The technologies used in the process with intermediate distillation and in the integrated processes with intermediate stripping with pressurized hydrogen are not equivalent and cannot be combined: it is not possible to carry out simultaneous hydrogen stripping under high pressure and distillation at moderate or atmospheric pressure, nor is it possible to use both a non-integrated process and a highly integrated process.

However, the Applicants have surprisingly discovered that it is possible to carry out a process having the advantages of the processes described above without their drawbacks. The process of the invention can in particular:
provide high energetic efficiency, not necessitating a high energy consumption such as that encountered in fractionation by distillation;
require limited or zero intermediate cooling of the effluent from the first hydrotreatment step and as a result it requires smaller heat exchange surfaces than in the processes described above;
carry out stripping without notable depressurization and without requiring a pump to take up the product stripped at a high differential pressure;
extract a portion of the liquid feed upstream of the second hydrotreatment step without deleteriously affecting the mean sulphur content of the products leaving the unit and as a result, the dimensions of the reactor for the second hydrotreatment step can be reduced.

### DESCRIPTION

A typical feed for the process of the invention is a middle distillate feed. Within the context of the present invention, the term “middle distillate” designates hydrocarbon fractions boiling in a range of about 130° C. to about 410° C., generally about 140° C. to about 375° C., for example about 150° C. to about 370° C. A middle distillate feed can also include a gas oil or diesel cut or be designated by one of these terms.

The process of the present invention can also be applied to the treatment of straight run hydrocarbon fractions with a boiling point located in the naphtha range: it can be used to produce hydrocarbon cuts for use as solvents or diluents and preferably containing a reduced aromatic compound content; the term “naphtha” designates a hydrocarbon fraction comprising hydrocarbons containing 5 carbon atoms to hydrocarbons with an end point of about 210° C.

The process can also be used for the hydrotreatment and desulphurization of gasoline, in particular gasoline produced in a fluid catalytic cracking unit (FCC) or other gasoline fractions deriving, for example, from cokefaction, visbreaking, or residue hydroconversion units, the term “gasoline” designating a hydrocarbon fraction from a cracking unit boiling between about 30° C. and about 210° C.

A further possible feed is kerosene. The term “kerosene” designates a hydrocarbon fraction boiling in the range about 130° C. to 250° C.

The process of the invention can also be used for hydrotreating heavier cuts, such as a vacuum distillate boiling in the range about 370° C. to 565° C.

The process of the invention can also be used for hydrotreating heavier cuts than a vacuum distillate, in particular deasphalted oil cuts.

The term “deasphalted oil” designates a cut boiling above about 565° C. (or at a slightly lower temperature such as about 525° C.) obtained by deasphalting a heavy residue, for example a vacuum residue, using a propane, butane, pentane, light gasoline type solvent or any other suitable solvent that is known to the skilled person.

Finally, the process can be used for hydrotreating a broader hydrocarbon cut resulting, for example (in a non limiting manner,) from mixing at least two of the fractions defined above.

It is also possible to use residual feeds, for example the vacuum residue boiling above about 565° C. and comprising asphaltenes, non-vaporizable.

The process of the invention comprises the following steps:
a first step a1) for hydrotreatment in which said feed and excess hydrogen are passed over a first hydrotreatment catalyst to convert at least the major portion of the sulphur contained in the feed into H₂S;
downstream of step a1), a step a2) for stripping the partially desulphurized feed from step a1) in a pressurized stripping column using at least one hydrogen-rich stripping gas, to produce at least one gaseous effluent at the column head and at least one stripped liquid effluent, the gaseous effluent at the column head being cooled and partially condensed, then separated in at least one stripping step gas/liquid separator, into at least one light hydrocarbon liquid fraction and a gaseous stripping step effluent;
downstream of step a2), a second hydrotreatment step a3) in which the stripped liquid effluent and excess hydrogen are passed over a second hydrotreatment catalyst.

In the process of the invention, the following operations are also carried out:
in an upper portion of the stripping column located above the supply to said column, a step for rectification of stripping vapours rising above the supply is carried out using a liquid reflux with a sulphur content of less than about 50 ppm;
at least a portion of the light hydrocarbon liquid fraction is taken off and evacuated directly downstream;
the following parameters are selected: the temperature of the supply to the stripping column, the stripping gas flow rate, and the liquid reflux flow rate, so that the stripped liquid effluent represents at most 90% by weight of the feed supplied to step a1), and in combination with said parameters, the degree of desulphurization of step a1) is determined along with the efficiency of separation of the rectification step, such that the sulphur content in said light hydrocarbon liquid fraction is less than about 50 ppm.

The sulphur contents of the liquid reflux and the light hydrocarbon liquid fraction must be included, in accordance with the invention, as are the organic sulphur contents (contained in the sulphur-containing hydrocarbons). Said liquid streams can also contain substantial quantities of H₂S in the dissolved form in the liquid hydrocarbon phase.

In the process of the invention, the portion of the light hydrocarbon fraction which is evacuated directly downstream is extracted to any complementary hydrotreatment and is thus not recycled to step a1) nor is it supplied to step a3) nor to any other hydrotreatment step. This removed portion is often individualized, i.e., evacuated only downstream; as an alternative, it can also be mixed with a portion or all of the hydrotreated liquid fraction (often upstream of the stripping step gas/liquid separator, which is generally the column reflux drum) and evacuated downstream as a mixture.

The process of the invention thus carries out deep desulphurization of the feed in a first reaction step so that the light fractions of said feed, which are typically the least refractory to desulphurization (in particular in the case of diesel or gas oil cuts, i.e. middle distillates), are deeply desulphurized while the heavy fractions still contain more refractory sulphur-containing compounds; in combination with said deep desulphurization, the stripping and rectification conditions are determined so that a sufficient fractionation quality is obtained that does not pollute the light hydrocarbon liquid fraction produced by the heavier sulphur-containing compounds. This means that a substantially desulphurized fraction can be extracted from the feed to the second reaction step and that the dimensions of the reactor for the second step can be reduced.

The process of the invention is thus particularly suitable for deep desulphurization in two steps using a highly efficient catalyst in the second step for desulphurizing compounds that are relatively refractory to desulphurization, for example a platinum/palladium on alumina catalyst. Said catalyst is highly effective but expensive, and the catalytic volume can be substantially reduced by reducing the quantity of feed supplied to this reaction step. The stripping column with rectification thus has a double function: firstly, it eliminates pollutants and in particular H₂S from the supply to the second hydrotreatment step, and secondly, it evacuates a desulphurized light fraction, reducing the quantity of feed supplied to the second hydrotreatment step and thus the catalytic volume and dimensions of the reactor for that step.

The process of the invention is also suitable when both deep desulphurization and medium or moderate dearomatization is sought, said dearomatization not necessitating treatment of the whole of the feed in the second hydrotreatment step.

The process is not limited to desulphurization and possibly to dearomatization, but can also be combined with other reactions, in particular denitrogenation and possibly with demetallization.

The search for the production in the stripper of a light desulphurized fraction in substantially quantities (and not solely a gas rich in H₂S) also means that the temperature of the supply to the stripping column can be increased, and thus cooling of the effluent from the first step upstream of said column can be reduced or dispensed with, which means that the heat exchange surfaces required can be reduced with respect to known two-step hydrotreatment processes.

The process of the invention can exist in a number of variations or embodiments, as will be explained below:

In general, the effluent from step a3) is cooled then separated in a second reaction step (or second hydrotreatment step) gas/liquid separator into a hydrotreated liquid fraction and a gaseous effluent from the second reaction step. In a variation, the effluent from said step a3) can also be mixed with the gas effluent from the column head, or the gas effluent from the stripping step, for example to treat the effluents or the recycle gases from the two reaction steps together.

Treatments for purifying recycle gas can include H₂S elimination, for example by amine washing and/or dehydrogenation and/or other treatments, in particular purifying residual H₂S traces, for example by capture on a zinc oxide bed. However, recycle gas purification treatments can optionally be carried out on the single recycle gas sent to the second reaction step a3).

Thus, the second reaction step a3) can be carried out:
either using the purified recycle gas;
or using makeup hydrogen (substantially free of impurities) in direct circulation without recycling;
or using a separate recycle loop for step a3) (with no mixing point or common portion with the loop for the first reaction step a1)), said loop preferably being supplied only by makeup hydrogen substantially free of impurities. This variation of the two-step hydrotreatment and hydrogen stripping process with two separate recycle loops forms the subject matter of a patent application made simultaneously with the present application. In that process, treatment of the recycle gas with amines can optionally be carried out on the only recycle gas for recycling to the first reaction step a1). It is also possible not to carry out the recycle gas amine treatment, the second loop being supplied with makeup hydrogen which is substantially free of impurities. This avoids carrying out this expensive recycle gas amine washing step.

Preferably, the (organic) sulphur content of the liquid reflux and that of the light liquid (hydrocarbon) fraction are less than about 30 ppm, often less than about 20 ppm and even 15 ppm, with more preferred contents being less than 10 ppm. This means that the operation is carried out with a high degree of desulphurization in the first reaction step a1) so that the lightest fractions in the feed are deeply desulphurized to the contents described above, and in particular to the specifications required for using that fraction, alone or as a mixture (for example the specifications of a diesel fuel). This high degree of desulphurization in the first reaction step a1) also means that it is possible to use a portion of the light hydrocarbon liquid fraction as a substantially desulphurized liquid reflux, allowing the sulphur-containing products to flow back to the bottom of the stripping column, in particular relatively heavy sulphur-containing compounds.

Preferably, the respective degrees of desulphurization of the two (or more) hydrotreatment steps and the nature of the hydrotreatments (in particular their desulphurization efficiency and also their denitrogenation and/or dearomatization efficiency) will be determined so that the mixture of the two liquid effluents (light hydrocarbon liquid fraction takeoff and the hydrotreated liquid fraction) satisfy the required specifications (generally after a step for stabilizing this mixture to eliminate residual H₂S and fractions that are too light to satisfy the specifications, for example regarding the initial point, or the light compound contents, or the distillation interval). In particular, care is taken so that preferably, for a diesel fuel, the product resulting from mixing the two liquid effluents from the unit has, after stabilization, a sulphur content of less than 50 ppm, often less than 30 ppm and even less than 20 ppm, preferably less than 15 ppm and highly preferably less than 10 ppm, for example less than 5 ppm, and a cetane index that satisfies the current specification.

Preferably, the liquid reflux can comprise a fraction of said light hydrocarbon liquid fraction, and can for example be constituted by a portion or, as is preferable, all of the residual fraction of said light hydrocarbon fraction, after removing the portion evacuated directly downstream. Generally and preferably, the liquid reflux is a portion of the light hydrocarbon feed and thus has the same sulphur content as said light hydrocarbon liquid fraction.

The liquid reflux can also comprise or be constituted by a fraction of said hydrotreated liquid fraction or also a mixture of a portion of said hydrotreated liquid fraction with a portion of the light hydrocarbon liquid fraction, the liquid obtained in both cases having a very low sulphur content. In the latter case, mixing is generally carried out by contact between the hydrotreated liquid fraction, or a portion of said hydrotreated liquid fraction, and the head effluent from the stripping column, upstream of the stripping step gas/liquid separator (or an optional second separator).

Preferably, the effluent from the column head is cooled in a single step, to reach a temperature that is generally in the range 20° C. to 250° C., often less than 100° C., usually less than about 70° C., for example close to 50° C.

It is also possible to cool the effluent from the column head in two steps and to carry out:
a first cooling step with partial condensation of the column head effluent followed by gas/liquid separation in a reflux drum (or a first stripping step gas/liquid separator) and, for example, to return all of the condensed liquid to the column (preferably as a liquid reflux, and/or optionally partially with the supply), the temperature at said reflux drum being in the range about 80° C. to 250° C., for example, and such that a substantial quantity of hydrocarbons remains in the gas from said separator drum;
complementary cooling of the gas from said first separator drum, followed by gas/liquid separation in a second stripping step gas/liquid separator, to condense and evacuate a light hydrocarbon liquid fraction alone or mixed with a contact liquid (for example the hydrotreated liquid fraction). Said (optional) contact liquid, preferably introduced upstream of the second gas/liquid separator, is generally capable of absorbing light hydrocarbons, to thereby eliminate light hydrocarbons from the recycle loop and increase the purity of the hydrogen in that loop.

Frequently, the rectification step is carried out in a rectification zone with a separation efficiency in the range 1 to 30 theoretical plates, limits included, and preferably in the range 2 to 20 theoretical plates and highly preferably in the range 5 to 14 theoretical plates, limits included (conventionally, the separating efficiency of the rectification step is equal to the separation efficiency of the rectification zone). With a substantially desulphurized liquid reflux, said rectification section allows the relatively heavy sulphur-containing products, for example dibenzothiophenes, to flow back to the column bottom.

The stripping zone of the stripping column (the zone located below the supply) can, for example, have an efficiency corresponding to 3 to 60 theoretical plates, and generally 5 to 30 theoretical plates, for example 8 to 20 theoretical plates, limits included.

The flow rates of the liquid reflux and the stripping gas depend on a number of parameters including, for example, the temperature of the supply to the stripping column and the quantity of light hydrocarbon liquid fraction taken off. These parameters are preferably determined in combination (and not independently). Generally, the stripping gas flow rate is in the range 2.5 to 520 Nm³ μm³ of feed supplied to step a1), and usually in the range 5 to 250 Nm³/m³ of feed supplied to step a1). Preferably, the stripping gas flow rate corresponds to about 5% to 150%, highly preferably to 10% to 100% of the hydrogen consumed in step a1) (assuming that the hydrogen in this stripping gas flow is completely consumed).

The quantity of liquid reflux is generally in the range from 0.05 to 1.2 kg/g of liquid feed supplied to step a1), and usually in the range 0.15 to 0.6 kg/g of liquid feed supplied to step a1).

Preferably, a reflux ratio for the rectification zone (weight ratio between the liquid reflux and the light hydrocarbon liquid fraction takeoff) is in the range 0.05 to 20. When the reflux is exclusively constituted (the most frequent case) by a portion of the hydrocarbons contained in the column head effluent and condensed after cooling (and does not comprise a portion of the hydrotreated liquid fraction), the reflux ratio is highly preferably in the range 0.25 to 3.

When the reflux comprises a portion of the hydrotreated liquid fraction, it is preferable to use a quantity of liquid reflux selected from the range indicated above, or to use a reflux ratio in the range cited above, calculating it with respect to the light hydrocarbon liquid fraction takeoff even if that fraction is not individualized but evacuated as a mixture with a portion of the hydrotreated liquid fraction.

Appropriate (sufficient) flows of stripping gas and liquid reflux can readily be determined by the skilled person for the desired separation conditions, by computer simulation of the fractionation.

Preferably, the gaseous effluent at the column head is cooled and partially condensed then separated in a stripping step gas/liquid separator into a light hydrocarbon liquid fraction and a gaseous stripping step effluent; preferably, a portion of said light hydrocarbon liquid fraction is then removed and evacuated directly downstream, the complementary portion of said light hydrocarbon liquid fraction takeoff usually being returned in its entirety to the stripping column and directly used as the liquid reflux (without either complementary hydrotreatment or heat exchange) or after an optional heat exchange over a portion or all of said complementary portion. Generally, the whole of the complementary portion is used as a reflux. The scope of the invention also encompasses returning a fraction of said complementary portion as a mixture with the effluent from step a1), for example to adjust or control the column feed temperature. The portion returned as a reflux and/or that returned with the feed can optionally be reheated separately or as a mixture in one or more heat exchangers.

Typically, the light hydrocarbon liquid fraction takeoff represents at least 10% by weight of the feed to step a1). Frequently, the light hydrocarbon liquid fraction takeoff represents at least 20% by weight of the feed for step a1), and the stripped liquid effluent represents at most 80% by weight of the feed for step a1). Preferably, said light hydrocarbon liquid fraction takeoff represents between 20% and 70% by weight of the feed for step a1), and the stripped liquid effluent represents between 30% and 80% by weight of the feed for step a1). Highly preferably, said light hydrocarbon liquid fraction takeoff represents between 30% and 60% by weight of the feed for step a1), and the stripped liquid effluent represents between 40% and 70% by weight of the feed for step a1).

If the quantity of relatively heavy sulphur-containing compounds (for example dibenzothiophenes) present in the light hydrocarbon liquid fraction is too high, the quantity of light hydrocarbon liquid fraction takeoff can be reduced so that those compounds are preferentially found in the stripped liquid effluent; it is also possible to improve fractionation by increasing the number of theoretical plates for rectification and/or by increasing the flow rate of the recycle gas and the reflux ratio; finally, it is possible to increase the degree of desulphurization of step a1) to adjust the sulphur content in the light hydrocarbon liquid fraction.

Said evacuation in the process of the invention of a large and substantially desulphurized fraction of the feed from the first step (typically at least 10% by weight and usually 20% or more) does not logically follow from the technology of prior art processes with intermediate pressurized hydrogen stripping. Those processes seek to limit the quantity of middle hydrocarbons (in the diesel fuel range, for example) contained in the stripping vapours, and to this end they carry out substantial cooling (typically by at least 100° C.) of the effluent from the first reaction step before supplying the stripping column. In those processes, the recovered light fraction is typically recycled to the first hydrotreatment step, and does not have the required sulphur specification.

In contrast, the process of the invention preferentially uses a combination of technical means, in particular a relatively high column inlet temperature associated with a sufficient stripping gas flow rate so that the stripping vapours contain a large quantity of light and middle hydrocarbons can be condensed and evacuated without undergoing complementary hydrotreatment. In combination with said vaporization and relatively high degree of stripping, in the stripping column, the process of the invention preferentially employs two dispositions of the process which are neither described nor suggested in the prior art:
the use of sufficiently severe conditions in the first hydrotreatment step to carry out very deep desulphurization of the lightest fractions in the feed (to less than 50 ppm of sulphur, in particular less than 30 ppm, and preferably less than 20 ppm or even less than 15 ppm and highly preferably less than 10 ppm of sulphur, for example about 5 ppm of sulphur);
the use of a section for rectification of the stripping vapours, under conditions (in particular the number of theoretical plates, the liquid reflux flow rate and the very low sulphur content of the reflux liquid) that can obtain a sufficient fractionation quality to be able to produce and take off a substantial quantity of light hydrocarbon liquid fraction substantially desulphurized to the sulphur contents cited above, all without polluting said cut with heavier hydrocarbons with a high sulphur content, which are returned to the bottom of the column due to rectification with the substantially desulphurized liquid reflux.

Preferably, the effluent from hydrotreatment step a1) is supplied to the fractionation column with a possible temperature difference of at most 90° C. with the temperature at the outlet from the reaction step a1) (temperature at the outlet from the reactor or last reactor if step a1) is carried out in a plurality of reactors). This temperature difference is highly preferably less than about 70° C. and often less than about 50° C. It can also be substantially zero.

In a preferred variation of the process of the invention, the effluent from hydrotreatment step a1) is then supplied directly to the fractionation column at a temperature that is substantially identical to the temperature at the outlet from reaction step a1).

In a further preferred variation of the process of the invention, the effluent from hydrotreatment step a1) is supplied to the fractionation column after limited cooling by at most 90° C., preferably at most 70° C., and highly preferably at most 50° C.

In a further variation of the process of the invention, the effluent from hydrotreatment step a1) is supplied to the fractionation column after limited reheating by at most 90° C., preferably at most 70° C. and highly preferably at most 50° C.

In these three variations, there is no need to carry out major cooling of the effluent from the first hydrotreatment step a1) prior to carrying out the stripping step, which then benefits from high enthalpy for supplying to the stripping column. This also contributes to increasing the quantity of vaporized hydrocarbons and thus the quantity of liquid reflux that can be used for a given quantity of light hydrocarbon liquid fraction takeoff and evacuated directly downstream, which improves the quality of the fractionation carried out and thus the sulphur content of the light hydrocarbon liquid fraction takeoff evacuated directly downstream. The installation costs are also reduced because of the reduction in the exchange surfaces that are required (zero cooling or less cooling).

Usually, the effluent from hydrotreatment step a1) is supplied to the fractionation column at a temperature in the range from about 255° C. to about 390° C., preferably at a temperature in the range from about 270° C. to about 390° C. and highly preferably at a temperature in the range from about 305° C. to about 390° C., in particular at a temperature in the range from about 315° C. to about 380° C.

Lower temperatures, such as temperatures in the range 180° C. to 255° C. can also be used, but in that case, increased quantities of hydrogen must be used as the stripping gas.

With identical quantities of stripping gas, the quantity of light hydrocarbon liquid fraction which can be removed is then generally lower than with a higher supply temperature.

When treating a gas oil cut, middle distillate or diesel fuel base, the fractionation conditions and in particular the parameters for the rectification section (number of theoretical plates and reflux quantity or ratio) are preferably selected so that the removed light fraction is substantially free of relatively heavy compounds that are relatively difficult to desulphurize, such as dibenzothiophenes. Then, for example, it is possible to select the cut point between the light hydrocarbon liquid fraction and the stripped liquid fraction, preferably between 200° C. and 315° C., and highly preferably between 235° C. and 312° C., for example between 250° C. and 305° C. It is also possible to select the 95% by weight point of the light hydrocarbon liquid fraction, preferably between 200° C. and 315° C., highly preferably between 235° C. and 312° C., for example between 250° C. and 305° C.

The pressure of the stripping column (column head) is typically close to the outlet pressure from the first reaction step and the first hydrotreatment reactor, for example lower by about 0 to 1 MPa, preferably about 0 to 0.6 MPa, and highly preferably about 0 to 0.4 MPa than that at the outlet from the first hydrotreatment reactor.

The degree of hydrodesulphurization in step a1), high in the process of the invention, is adjusted so that the sulphur content in the light hydrocarbon liquid fraction is very low: less than about 50 ppm, in particular less than 30 ppm and preferably less than 20 ppm, in particular less than about 10 ppm, for example less than 5 ppm.

The degree of hydrodesulphurization in step a1) is also adjusted so that the sulphur content of the stripped liquid effluent is limited, and compatible with good efficiency of the catalyst for the second reaction step a3).

In one preferred mode of the process of the invention, which can be used when processing diesel cuts or middle distillates, both sufficiently severe conditions for the first reaction step a1) and a cut point and adequate fractionation conditions between the light hydrocarbon liquid fraction and the stripped liquid effluent are selected so that the light hydrocarbon liquid fraction is severely desulphurized (to at most 50 ppm, usually at most 30 ppm, in particular at most 20 ppm, preferably at most 10 ppm or even 5 ppm) while the heavier fractions of the stripped liquid effluent, which are relatively difficult to desulphurize, still contain large quantities of sulphur-containing products (for example dibenzothiphenes). This can be achieved by selecting sufficiently severe desulphurization in the first step to substantially completely desulphurize the light fractions, which are relatively easier to desulphurize, but insufficient to completely desulphurize the heavier fractions, which are more refractory to desulphurization. The amount of residual (organic) sulphur in the total feed at the end of the first step a1) is then generally in the range from about 50 to about 2000 ppm, usually in the range from about 70 to 1000 ppm, and very often in the range 100 to 450 ppm.

In certain cases it is also possible within the context of the invention to carry out very severe desulphurization in step a1) to achieve an overall sulphur content in the feed of less than 50 ppm, less than 10 ppm or even less than 5 ppm of sulphur, for example, step a3) then often being essentially a hydrogenation step.

The range of most appropriate sulphur contents for the stripped liquid effluent depends on the type of catalyst used in step a3):

It can optionally be of the order of 200 to 2000 ppm or more if a conventional catalyst is used in step a3), for example a nickel/molybdenum on alumina type catalyst.

When the catalyst of step a3) has a higher sensitivity to sulphur (for example a platinum/palladium catalyst), then the conditions of step a1), the cut point and the fractionation conditions, are preferably selected so that the stripped liquid effluent is desulphurized, for example to a residual content of at most about 500 ppm of sulphur, preferably at most about 250 ppm and highly preferably at most about 200 ppm of sulphur, for example about 120 ppm of sulphur or less. The sulphur content corresponding to the overall feed at the outlet from step a1) is then usually in the range from about 100 to about 450 ppm. These values are not limiting, however, and depend on the thioresistance of the platinum/palladium catalyst employed. The scope of the invention encompasses using the platinum/palladium catalyst in step a3) with a less desulphurized feed, for example 1000 ppm of sulphur or more.

To obtain both severe desulphurization of a light portion of the feed and sufficient desulphurization of the stripped liquid effluent, it is possible:
to adjust the severity of the desulphurization carried out in step a1) and use sufficiently severe conditions in step a1) (HSV=space velocity: low, high temperature, high partial pressure of hydrogen, efficient catalyst which is suitable for the feed). The choice of catalyst and the operating conditions depends a great deal on the feed being processed, but can readily be determined for a given feed by the skilled person;
to determine a cut point and sufficiently effective fractionation conditions, in particular the number of theoretical plates in the rectification zone, the flow rate of the liquid reflux and the sulphur content in the liquid reflux, so that the light hydrocarbon fraction has the desired sulphur content and is not polluted by heavy sulphur-containing products.

These operations do not require the parameters to be determined with a single solution for each thereof, or very accurately: it is possible to use a wide range of operating parameters, in particular a degree of desulphurization in step a1) that can vary within a wide range, which is possibly beyond the minimum degree, and/or with a higher number of theoretical plates than strictly necessary, and similarly a cut point that is a little lower than theoretically possible in order to produce sufficient operational allowances in the event that the characteristics of the feed are modified.

All of these parameters can be readily determined by the skilled person, who for different catalysts and different feed qualities will have to hand correlations between the degree of desulphurization and the hydrotreatment operating conditions, and will also have computer simulation means that can simulate fractionation of a stripping column with an additional rectification section. Optionally, the skilled person could also use the results of laboratory tests with greater or lesser desulphurization of the feed under consideration, and analysis of the distribution of sulphur into different fractionated cuts (by varying the cut point).

One method for finding suitable design conditions and operating conditions is described below in broad outline. The skilled person could use or adapt this or other possible methods to carry out the invention:
it is possible to start by determining the “initial” conditions for the severity of step a1), in particular a sufficient degree of desulphurization so that a light portion of the treated cut and the residual heavy portion are desulphurized to at least the desired level. As an example, if a light hydrocarbon fraction representing 20% by weight of the initial feed and having at most 10 ppm of sulphur is to be produced and evacuated directly downstream, sufficiently severe conditions for step a1) could be determined so that the light fraction corresponding to the 20% by weight ideal cut point is desulphurized to about 10 ppm, or more severe conditions if the sulphur content in the residual heavy fraction is too high for the catalyst to be used in step a3);
then the “initial” or “first iteration” operating conditions for the column are selected taking, for example, a separation efficiency of 5 theoretical plates for rectification and 15 for stripping, a reflux mass flow rate equal to the quantity of light hydrocarbon liquid fraction which is to be removed (the liquid reflux used being a portion of the light hydrocarbon liquid fraction produced), a flow rate for the stripping gas corresponding to 100% of the hydrogen consumed in step a1), etc, for example, the column supply temperature being determined to produce the desired quantity of light hydrocarbon liquid fraction. Computer simulation then produces the “initial” functional conditions (in particular the column bottom temperature) and the fractionation achieved using said conditions;
then, preferably, the functional conditions are modified to improve the possibilities of energetic integration by modifying the different parameters (for example the flow rate of the stripping gas, the liquid reflux flow rate, etc), so that the column supply temperature is preferably close to the outlet temperature of the reactor of step a1), so that the temperature of the stripping step gas/liquid separator is preferably compatible with conventional means for cooling effluent from step a1) etc. Then, the sulphur content of the light hydrocarbon liquid fraction obtained by the simulation and that of the stripped liquid fraction obtained by simulation are determined. These modifications can be made in one or more iterative steps;
the desulphurization severity in step a1) is then adjusted along with the separation efficiency of the rectification zone to adapt the sulphur content of the light hydrocarbon liquid fraction to the desired value, optionally with a safety margin. The fractionation carried out in the stripping column and in particular in the rectification zone is not ideal; the light hydrocarbon liquid fraction is not actually free of small quantities of sulphur-containing products that are heavier than the (ideal) cut point. Adaptation of the mean degree of desulphurization in step a1) and/or in combination with an adaptation of the separative efficiency of the rectification zone can then limit the presence of said small quantities of relatively heavy sulphur-containing products, and can compensate for the presence of traces of said sulphur-containing products by a reduction in the mean sulphur content of other compounds in the light hydrocarbon liquid fraction. The desired sulphur content can then be obtained. If the stripped liquid effluent has too high a sulphur content as regards the catalyst envisaged in step a3), the degree of desulphurization in step a1) can then be further increased, or a catalyst that is less sensitive to sulphur can be selected for step a3).

In a further implementation of the process of the invention, which can be used when the catalyst of step a3) is highly sensitive to sulphur (for example a platinum catalyst selected principally to carry out hydrogenation of aromatics in step a3)), the conditions for step a1) are selected so that the total effluent from this step and also the stripped liquid are deeply desulphurized, for example to a residual content of at most about 200 ppm and preferably at most about 100 ppm, in particular at most about 50 ppm, and highly preferably at most about 10 ppm of sulphur or an even lower content.

In the process of the invention, hydrotreatment step a3) can optionally be carried out with at least one catalyst comprising at least one noble metal or a compound of a noble metal selected from the group constituted by palladium and platinum (for example of the platinum on alumina type, preferably platinum/palladium on alumina). This variation in the process of the invention can have a second reaction step a3) having a high activity for aromatic hydrogenation; thus, step a1) often principally carries out desulphurization (generally with a conventional catalyst, for example of the cobalt/molybdenum or nickel/molybdenum on alumina type), while step a3) typically carries out complementary desulphurization and aromatic hydrogenation, in particular to improve the cetane index. Said catalysts of the noble metal or noble metal compound type can, depending on their formulation and their manufacturing process, have different resistances to different impurities such as H₂S, NH₃, and also H₂O. The platinum on alumina type catalysts are generally more sensitive to sulphur and water than platinum/palladium on alumina type catalysts, the latter catalysts generally being much more sensitive to sulphur and water than conventional catalysts such as cobalt/molybdenum or nickel/molybdenum on alumina catalysts.

Regarding the admissible water content in step a3), advantageously, if the catalyst is of the noble metal (or noble metal compound) type, it is possible to use a stripping gas that is substantially free of water (less than 2 ppm, for example) and, if necessary, to dehydrate the recycle gas supplied to step a3) to the desired level (for example less than 500 ppm, or 100 ppm, or 10 ppm, or even 2 ppm, using a drying agent that is known to the skilled person). The stripping gas with a very low water level or which is substantially free of water strips water contained in the liquid portion of the feed at the supply to the stripping column.

In general, in the case of a catalyst for step a3) of the noble metal (or noble metal compound) type, a favourable technical element that can reduce the impurities in step a3) is to eliminate the impurities (in particular H₂S, NH₃, and possibly H₂O) as far as possible at the stripping column. To this end, the stripping column is preferably supplied with stripping hydrogen (hydrogen-rich gas) using treated and purified hydrogen and/or makeup hydrogen deriving from one or more sources that are substantially free of impurities preferably containing, for example, less than about 5 ppm and preferably less than 2 ppm of H₂S or NH₃, and possibly a small amount of water, for example less than 500 ppm, or 100 ppm, for example less than 10 ppm, or even less, depending on the sensitivity to water of the catalyst or catalysts of step a3). These conditions are generally combined in practice, if (as is conventional) the stripping gas is makeup hydrogen derived from a catalytic reforming unit and/or makeup hydrogen deriving from a steam reforming unit and which has undergone purification on a molecular sieve or on a further solid adsorbent bed (known to the skilled person as PSA, pressure swing adsorption).

Finally, a third favourable technical element relating to the sulphur and impurities content in reaction step a3) (the first element being the amount of organic sulphur in the stripping liquid effluent and the second element being the amount of sulphur and other impurities in the stripping gas), is the amount of sulphur and other hydrogen impurities of the recycle gas supplied to the reaction step a3).

In a variation of the process of the invention, the second hydrotreatment step a3) is carried out in the presence of excess hydrogen constituted by makeup hydrogen circulating in a single pass and the gaseous effluent from the second reaction step (separate from the outlet from step a3)) is recycled to step a1). This variation can be used if a large portion of the makeup hydrogen is consumed in the first step and if, as is preferable, a relatively high fraction of the light hydrocarbon liquid fraction is produced and taken off, so that the feed for step a3) is greatly reduced and needs only a limited quantity of hydrogen. In this case, it is possible to use all entirely makeup hydrogen, such as hydrogen from the second reaction step a3), which then functions without a recycle loop, the quantity of hydrogen at the outlet from step a3) remaining sufficient for the needs of the catalyst. This makeup hydrogen, if it derives from a catalytic reforming and/or steam reforming unit followed by a PSA unit, is substantially free of impurities and often has a high hydrogen purity (molar percentage), in particular after a PSA unit.

In a further variation of the process of the invention, the second hydrotreatment step a3) is carried out in the presence of a specific hydrogen recycle loop without a mixing point with the recycle loop of step a1). In that case, the recycle loop of step a3) is preferably supplied with makeup hydrogen, substantially free of impurities if that hydrogen derives from the sources cited above, and is not “polluted” with impurities that are often present in step a1), in particular by a high H₂S content.

In a further variation of the process of the invention, the second hydrotreatment step a3) is carried out in the presence of a hydrogen recycle loop that is common with that of the first step a1), or has a mixing point with the loop of step a1). In this case, it is necessary, if a very low H₂S content is to be benefited from in the second reaction step a3), to purify the recycle gas (or at least the fraction of this gas supplying step a3)) to remove almost all of the H₂ S upstream of the reaction step a3), and reduce the H₂S content, for example to 15 ppm or even 10 ppm, for example. This treatment can consist of washing the gas with a solution of amines, a technique that is well known to the skilled person, or by a further process that is known to the skilled person. This purification can optionally be followed by eliminating residual traces of H₂S using a further known process, for example by capture on a bed of zinc oxide. The gas can then be purified to less than 5 ppm and even less than 1 ppm of H₂S.

It is also possible to carry out purification or final purification of the gas by PSA type separation (adsorption).

Gas purification treatments are illustrated, for example, in European patent EP-A-0 1 063 275.

In the case in which the catalyst from step a3) is sensitive to water, it is also possible, preferably after the amine wash, to dry the recycle gas supplying said step on a solid molecular sieve type adsorbent (or another adsorbent such as alumina or silica gel) or by absorption of water, for example by washing with diethylene glycol or triethylene glycol, or using any other water elimination process that it known to the skilled person. Preferred residual water contents when using a noble metal or noble metal compound catalyst in step a3) are usually less than about 500 ppm, preferably less than 100 ppm, and highly preferably less than 10 ppm, or lower, the lowest values generally being used in the case of a platinum on alumina catalyst. Certain platinum/palladium on alumina type noble metal catalysts, however, can tolerate much higher water contents than those cited above.

In an optional preferred disposition of the process of the invention, washing water is injected into the vapour at the stripping column head, upstream of the cooling exchanger or exchangers (for example a recycle gas heat exchanger or an air-cooled exchanger) to capture nitrogen-containing compounds, in particular ammonia and ammonium sulphide formed in the reactor. The aqueous phase, which after mixing with the column head contains vapours a large portion of these undesirable compounds, is preferably recovered downstream in a stripping step gas/liquid separator drum also preferably carrying out decantation between the light hydrocarbon liquid fraction and the aqueous phase. The recovered aqueous phase is then evacuated.

The invention also concerns any hydrocarbon cut from the group constituted by gas, jet fuel, kerosene, diesel fuel, gas oil, vacuum distillate and deasphalted oil, containing at least one fraction hydrotreated using the process of the invention.

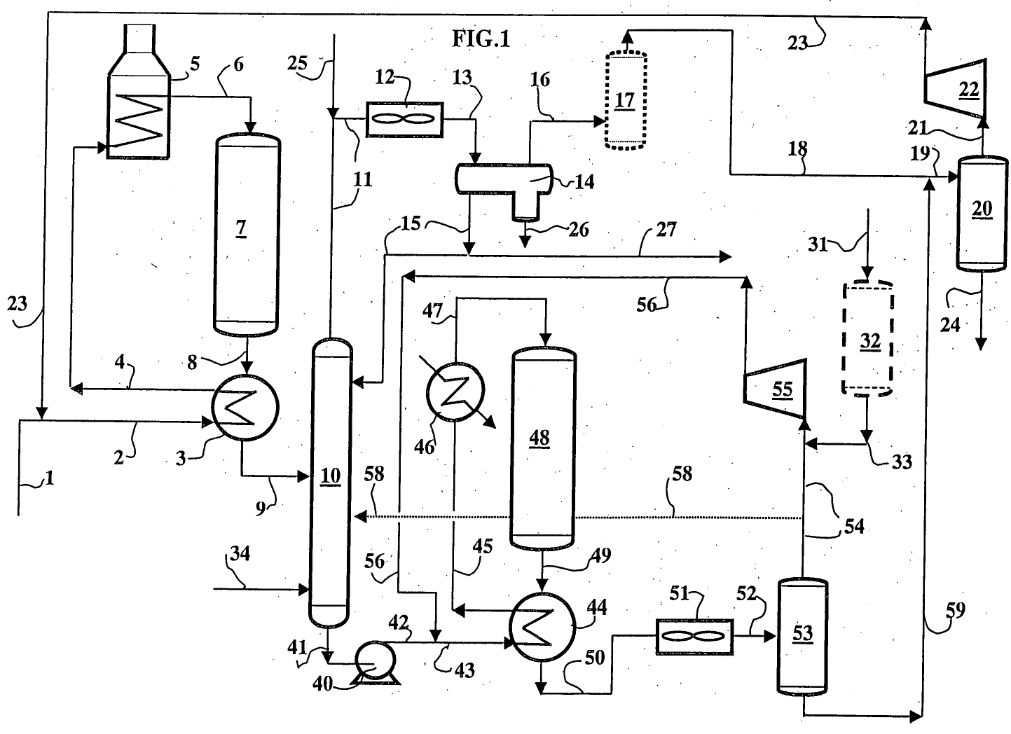

Four embodiments from the preferred modes for carrying out the process of the invention are shown in FIGS. 1 to 4.

FIG. 1 shows a flowchart for a hydrotreatment unit to carry out a first variation of the process of the invention, said unit comprising two separate hydrogen recycle loops with no mixing point.

The hydrotreatment unit feed, for example a straight run middle distillate type cut, is supplied via a line 1 and supplemented with a hydrogen-rich recycle gas stream moving in line 23. The mixture formed moves in line 2 and is reheated in the feed/effluent heat exchanger 3 then sent via line 4 to a furnace 5 in which its temperature is heated to the required temperature for the first reaction step a1). At the outlet from furnace 5, the reaction mixture moves in line 6 then supplies the hydrotreatment reactor 7 which is typically a fixed catalytic bed downflow reactor. The effluent from said reactor 7 (carrying out first reaction step a1)) is then sent via a line 8 to the feed/effluent exchanger 3 then supplied to a stripping column 10 via a line 9.

This column is also supplied with two sources of hydrogen-rich stripping gas which are supplied via lines 34 and 58: the gas supplied via line 34 is typically makeup hydrogen, with a medium or optionally high purity, and preferably substantially free of impurities such as H₂S and/or water vapour. This gas can, for example, derive from a catalytic reforming unit and/or a steam reforming unit, advantageously with final purification in a PSA type separation unit.

The second stream of stripping gas supplied via a line 58 is optional. Said stream derives from a possible excess of hydrogen-rich gas (makeup) supplied to step a3); the excess can then be used (in particular) as the stripping gas supplied via line 58. This use of excess makeup hydrogen in reaction step a3) increases the purity of the recycle gas in this step.

The stripping column can also be supplied from other sources of stripping gas not shown in FIG. 1; in particular, in some cases stripping gas (if sufficiently pure) taken from the recycle gas moving in line 23 could be supplied, being introduced into the column at or just above the supply of the purge gas for the REC2 loop via line 58.

In general, the stripping gas or gases supplying the column 10 may (in particular if they derive from the recycle loop), have previously been dried in a dryer (optional, not shown) to substantially eliminate water from the stripping step (more particularly if the catalyst from hydrotreatment step a3) contains a noble metal which is highly sensitive to water).

In general, the stripping gas or gases supplying the column 10 can also (in particular if they derive from the recycle loop) have been purified to remove at least the major portion of the H₂S, for example by washing with amines, then optional adsorption on a zinc oxide bed, to more completely strip H₂S at the stripping step (more particularly if the catalyst for hydrotreatment step a3) contains a noble metal which is highly sensitive to H₂S).

These purifications of the stripping gas or gases is, however, generally not necessary if the stripping gas is makeup hydrogen deriving from a catalytic reformer substantially without impurities. In the case in which the makeup hydrogen is at least partially produced by steam reforming, then preferably, after steam reforming, almost complete elimination of compounds other than hydrogen is preferably carried out on a molecular sieve or an equivalent adsorbent (PSA type separation) which produces very high purity hydrogen (generally more than 99.5).

The stripping column 10 comprises, above its principal feed (the effluent from reactor 7) a rectification zone with a separation efficiency that is, for example, in the range 5 to 14 theoretical plates, and a stripping zone for liquid flowing below the supply point with a separation efficiency that is, for example, in the range 8 to 20 theoretical plates.

The gaseous effluent from the head of column 10 moves in line 11 and is supplemented with washing water supplied via a line 25, and is then cooled with partial condensation in the air-cooled exchanger 12 then transferred via a line 13, prior to being separated in the stripping step gas/liquid separator drum 14. Said drum 14 carries out separation between three phases:
a gas stream or “gaseous stripping step effluent” sent to line 16;
a light hydrocarbon liquid fraction extracted via line 15, having a very low sulphur content, for example less than 10 ppm. A first portion of said light hydrocarbon liquid fraction is recycled to the column 10 as a liquid reflux, still via line 15; the residual liquid fraction or “light hydrocarbon liquid fraction takeoff portion” is taken off then evacuated downstream via a line 27 (i.e. it is not processed in the reaction step a3), nor in a further hydrotreatment step). Optionally, a portion of the light hydrocarbon liquid fraction can also be returned (via a line that is not shown in FIG. 1) and mixed with the supply to the stripping column to carry out limited cooling of the effluent from the reactor 7 immediately upstream of the column 10, and can optionally keep the temperature of the supply to the stripping column constant;
an aqueous liquid phase generally containing nitrogen-containing impurities evacuated via line 26.

The portion removed from the light hydrocarbon liquid fraction can, for example, represent about 30% by weight of the initial feed from step a1), which reduces the dimensions of the reactor of step a3) which is supplied with only about 70% by weight of the initial feed.

The liquid at the column bottom 10 or “stripped liquid effluent” is sent to the second reaction step a3) via a line 41.

The stripping step gas effluent moving in line 16 optionally traverses the equipment 17 to at least partially eliminate the H₂S contained in that gas. That equipment 17 can typically be a washer, or H₂S absorber using a solution of amines (inlet and outlet for the amine solutions are not shown in FIG. 1); it can also be a further device for eliminating H₂S and/or a device for eliminating H₂S and water, for example a series of an amine washer and a drier for gas purified of H₂S using one of the devices described above or a further device known to the skilled person. That equipment 17 (shown in FIG. 1 as a single piece of equipment but which can comprise two or more devices to eliminate H₂S then water) is optional: its use depends on a number of parameters, in particular on the sulphur content in the feed, and on the space velocity used in the first reactor 7, which if it is sufficiently low can allow the desired desulphurization in the first step a1) without amine washing in the REC1 loop.

At the outlet from said equipment 17, the gas moves in a line 18 and is supplemented with a stream of hydrotreated liquid fraction moving in a line 59 (the aim of this mixing or contact or contacting in line 19 is to capture and eliminate light hydrocarbons present in the recycle loop of step a1)), then rejoins the gas/liquid separator drum 20.

The liquid effluent from drum 20 or liquid contacting effluent is evacuated via a line 24 and constitutes a liquid effluent from the hydrotreatment unit (a further effluent, said “light hydrocarbon liquid fraction takeoff portion” is evacuated via line 27). These two effluents can optionally be mixed (they can also be brought into contact upstream of the gas/liquid separator drum 20 and leave together via line 24, or can be brought into contact upstream of the gas/liquid separator drum 14 and leave together via line 27), or fractionated separately downstream. Typically, the mixture of the two liquid effluents from the unit has a sulphur content of less than 50 ppm, in particular 30 ppm, preferably 10 ppm, for example about 5 ppm. The (optional) means for mixing and/or fractionating the two liquid effluents are not shown in FIG. 1.

The gas separated in drum 20 or “gaseous contacting effluent” is sent via a line 21 to a compressor 22 for the recycle gas, then recycled to the inlet to reaction step a1) via line 23.

The stripped liquid effluent moving in line 41 is pumped through the pump 40 to bring its pressure to a sufficient value for reaction step a3), said pressure in this example being higher than that in step a1). At the discharge from pump 40, the liquid is supplemented with hydrogen-rich gas supplied via a line 56 then moves in a line 43 traversing the feed/effluent exchanger 44, then moves in a line 45 and is heated (again) in the exchanger (or furnace) 46, then rejoins the reactor 48 of reaction step a3) via a line 47. At the outlet from said reactor, the effluent transits via a line 49, traverses exchanger 44, moves in line 50, and is cooled in air-cooled exchanger 51 then moves in a line 52 to reach the drum 53 termed the “second reaction step gas/liquid separator”. The liquid fraction termed the “hydrotreated liquid fraction” is sent to line 59 for mixing with the gas moving in the line 18 of the recycle loop for the first reaction step a1), and the gaseous fraction termed the “gaseous effluent from the second reaction step” is sent via a line 54 to the gas recycle compressor 55. Optionally, a portion of said gaseous fraction (possible excess gas, i.e., any purge gas in the hydrogen recycle loop of step a3)) is removed and sent via the (optional) line 58 to the lower portion of the stripping column 10 (and/or optionally to a further point in the hydrogen recycle loop of step a1) via means that are not shown).

A makeup hydrogen stream is then added to the residual gas stream moving in line 54 upstream of the compressor 55. This stream is supplied upstream via a line 31, optionally traversing a (optional) drier 32 (or preferably a separator and PSA type purifier) then moves in the line 33 connected to line 54.

After said addition of hydrogen, said gas is then compressed in the compressor 55 and recycled to the inlet to the reaction step a3) via a line 56.

In the unit of FIG. 1, the recycle loop of step a1) comprises the elements referred to hereinafter following the “gas path”: 21, 22, 23, 2, 3, 4, 5, 6, 7, 8, 3, 9, 10 (upper portion of the column located above the supply 9, the supplied gas rising in the column), 11, 12, 13, 14, 16, 17, 18, 19, 20, and 21 again which closes the loop.

The recycle loop of step a3) comprises the following elements: 54, 55, 56, 57, 43, 44, 45, 46, 47, 48, 49, 44, 50, 51, 52, 53 and 54 which closes the loop.

It can be seen that in the unit of FIG. 1, said recycle loops have no common parts, no mixing points. The loop of step a3) is exclusively supplied by the external makeup hydrogen (via line 33) which avoids pollution with impurities (H₂S, NH₃, possibly H₂O) and light hydrocarbons containing 1 to 4 carbon atoms, often present in the loop of step a1).

The unit can also comprise other elements that are not shown in FIG. 1, for example:
one or more quench gas lines originating from points on line 23 and supplying the reactor 7 at an intermediate position (in one or more zones each located between two consecutive catalytic beds);
one or more stripping gas supplies for the column 10 deriving from one or more points on line 23.

The unit can also comprise a line for evacuating purge gas from a point in the recycle loop for step a1) and/or a line for introducing makeup hydrogen at a point in this loop without passing via the stripping column (for example at line 23).

In the same manner, the recycle loop of step a3) could comprise elements that are not shown in FIG. 1, for example one or more quench lines deriving from points in line 56 and supplying the reactor 48 at an intermediate position (zones between catalytic beds). The unit can also comprise evacuating purge gas from a point in the loop for step a3) to supply the loop for step a1) or without the purge gas supplying the loop of step a1).

The scope of the invention also encompasses adding and/or removing heat exchangers or equivalent equipment and/or organizing the heat integration of the unit in a different manner. By way of non limiting example, the exchanger 46 of the loop of step a3) could be the furnace 5 itself (or also a portion of that furnace, in particular a portion of the convection zone of the furnace). It is also possible to preheat, with the effluent from step a3), the feed for step a1) and/or makeup hydrogen in particular for stripping and/or recycle gas for the loop for step a3), or to recover heat on the effluent at the head of the column 10 to heat, for example, the recycle gas for the loop of step a3) and/or recycle gas from the loop of step a1) and/or stripping gas and/or the feed for step a1). It is also possible to reheat the liquid reflux, for example to a temperature in the range from about 100° C. to 200° C., for example by heat exchange with the column head effluent, before re-introduction into the column etc.

Preferably, the feed for step a1) exchanges heat with the effluent from step a3) (in one or more heat exchanger(s) located on line 2, not shown in FIG. 1), so that the exchanger 3 has a cooling power for the effluent from reactor 7 that is limited to at most 90° C., preferably to at most 70° C., for example at most about 50° C.

The skilled person could also use other heat exchanges between the streams moving in the unit, depending on their respective temperatures.

The scope of the invention also encompasses modifying the position of the H₂S purification equipment 17, that equipment then being located downstream of the compressor 22 (on line 23).

Similarly, the scope of the invention encompasses a portion of said light hydrocarbon liquid fraction (different from the portion taken off) being recycled to step a1) or to a complementary hydrotreatment step. The conditions for step a1) are, however, preferably determined so that it is possible to evacuate the light hydrocarbon liquid fraction takeoff portion directly downstream, and optionally mix it with part or all of the hydrotreated fraction and/or to fractionate it (for example to eliminate H₂S and stabilize by stripping), alone or as a mixture, to allow its use as a diesel fuel, for example. Preferably, sufficiently efficient desulphurization in step a1) is employed so that the light hydrocarbon liquid fraction has a sulphur content that is compatible with its use, without subjecting any fraction of said light hydrocarbon liquid fraction to complementary hydrotreatment or recycling to step a1).

The scope of the invention also encompasses one or each of the two reaction steps a1) and a3) being carried out not in one but in two or even more reactors in series, optionally with intermediate adjustment of the temperature (by indirect heat exchange or quench with cold liquid or gas, or if one reactor comprised a plurality of reaction zones in series, with identical or different catalysts.

The hydrotreatment reactors (7, 48) are typically reactors with a fixed catalytic bed and a downflow for the gas and liquid. The scope of the invention encompasses whether one or more of the reactors is a further type or a plurality of other types, in particular of the moving bed type or an ebullated bed (because of introduction of the recycle gas) or in a fluidized bed (fluidized by the recycle gas), or with a fixed or moving bed in upflow mode for the gas and downflow mode for the liquid.

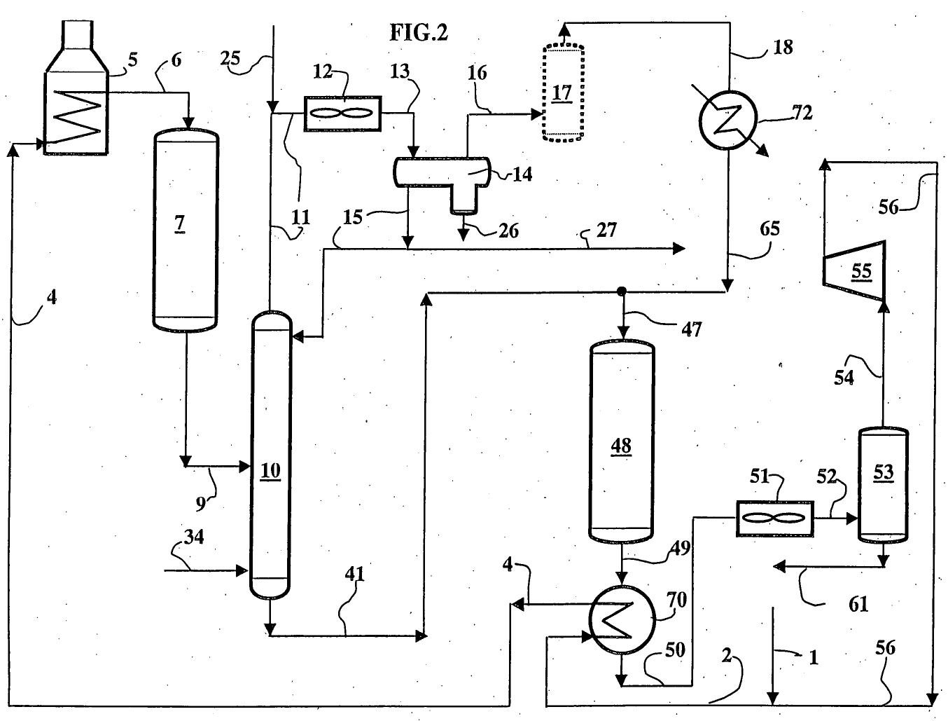

FIGS. 2, 3 and 4 show other variations of the unit for carrying out other variations of the process of the invention; the same reference numerals are used for elements common to several figures. These common elements will not in general be described again if they have already been described for another figure.

The variations in the unit of FIGS. 2, 3 and 4 comprise only a single hydrogen recycle loop and thus a single hydrogen recycle compressor in contrast to the unit of FIG. 1.

Reference will now be made to FIG. 2.

A first difference with the unit of FIG. 2 over that of FIG. 1 concerns the recycle loop. The unit comprises a single compressor 55 which compresses the recycle hydrogen for the two reaction steps, said recycle hydrogen moving in series in the two reaction steps, firstly in step a1) and then in step a3).

A further difference with the unit of FIG. 1 concerns the pumping or transfer means, linked to pressures in the different reaction steps. In contrast to the unit of FIG. 1, the unit of FIG. 2 uses a lower pressure in step a3) than in step a1). Thus, there is no need for a pump to transfer the stripping liquid effluent via line 41.

A further difference concerns contact between the hydrotreated liquid fraction and the gas of the recycle loop which is carried out in the unit of FIG. 2 downstream of the step a3) (at the gas/liquid separator 53), the separator drum 20 of FIG. 1 being dispensed with because a single recycle loop is used.

The feed for the unit of FIG. 2 moving in line 1 is supplemented with recycle hydrogen moving in line 56, then exchanges heat with the effluent from reactor 48 for the second reaction step a3) in the heat exchanger 70. This feed, supplemented with hydrogen and preheated, rejoins the section of the unit corresponding to the first reaction step a1). At the outlet from the reactor 7 for the first step a1), the effluent from this reactor is directly supplied to the stripping column 10 with neither reheating nor cooling. The stripped liquid effluent is also sent directly to the second reaction step a3) without supplemental reheating.

At the outlet from H₂S elimination equipment 17 (which may also eliminate water after eliminating H₂S if a water-sensitive catalyst is used in step a3)), the purified recycle gas moves in line 18 then is reheated in the heat exchanger 72, heat exchange being carried out (not shown in FIG. 2) between this purified gas and, for example, the effluent from sep a3) or the effluent from the column head 10. The purified and reheated recycle gas then rejoins the reactor 48 via line 65 then line 47 after adding that gas to the stripped liquid effluent which is supplied directly, i.e. without supplemental reheating.

A unit of the type shown in FIG. 2 can then have a relatively hot supply to the stripping column (for example about 310° C. to 350° C.) and can separate and remove a large quantity of light hydrocarbon liquid fraction representing, for example, about 30% by weight to about 70% by weight of the initial feed, said values not being limiting.

The makeup hydrogen is supplied via line 34 as the stripping gas, but could also be supplied in part or in its entirety to another point in the hydrogen recycle loop.

Said unit can, for example (in a non limiting manner), use a conventional catalyst in step a1), for example based on cobalt/molybdenum on alumina or nickel/molybdenum on alumina, and a noble metal catalyst in step a3), for example of the platinum/palladium on alumina type.

The other elements shown in FIG. 2 have already been described above with reference to FIG. 1.

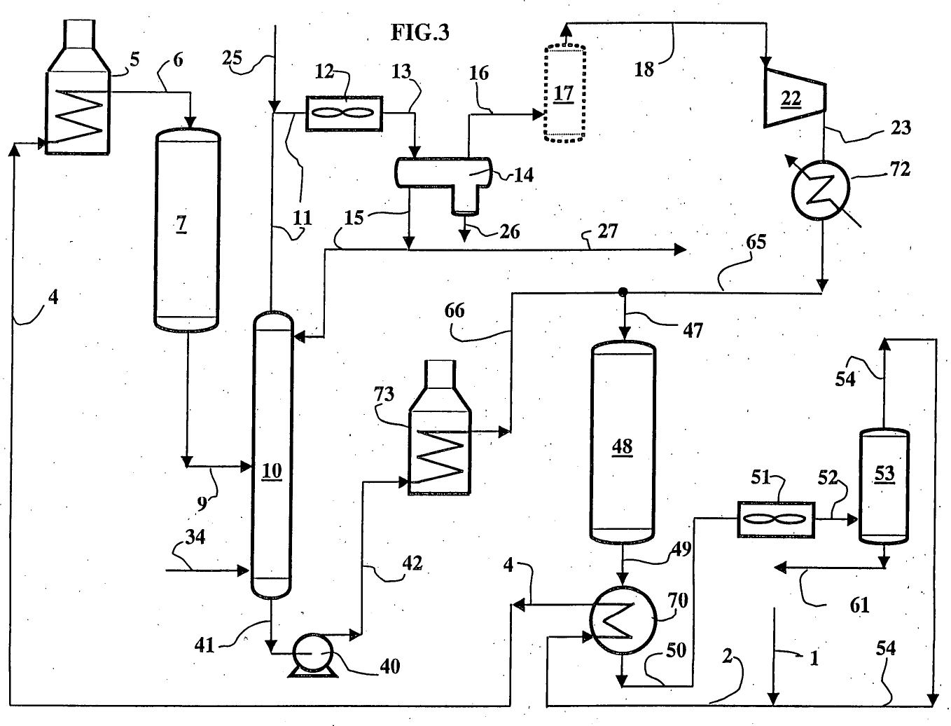

FIG. 3 shows a unit comprising, like the unit of FIG. 2, a single hydrogen recycle loop, said recycle hydrogen moving in series in the two reaction steps, firstly in step a3) then in step a1), i.e. in the reverse order to that of FIG. 2 if the starting point is the recycle compressor.

In the unit of FIG. 3, in contrast to that of FIG. 2, the pressure in the reaction step a3) is higher than that in the reaction step a1), and a pump 40 is used to transfer stripped liquid effluent which then moves in line 42, traverses the limited reheating furnace 73 then rejoins the mixing point with the recycle gas moving in the line 65 via line 66 before supplying the reactor for the second reaction step a3), via line 47. Typically, the furnace 73 ensures limited reheating of the stripped liquid effluent of at most about 90° C. and usually at most about 70° C., frequently at most about 50° C. Often, the temperature upstream of the furnace 73 is in the range 255° C. to 375° C., while the temperature at the outlet from the furnace 73 is in the range 285° C. to 390° C.

The feed for the unit supplied via line 1 is supplemented with recycle gas constituted by the gaseous effluent from the second reaction step moving in line 54 before rejoining the heat exchanger 70 via line 2 between the overall feed (i.e. with its recycle hydrogen) of step a1), and the overall effluent in step a3).

The other elements shown in FIG. 3 have already been described above with reference to FIG. 1 and/or FIG. 2.

A unit of the type shown in FIG. 3 can also have a relatively hot supply for the stripping column and can separate and take off a large quantity of the light hydrocarbon liquid fraction representing, for example, about 30% by weight to about 70% by weight of the initial feed, said values not being limiting.

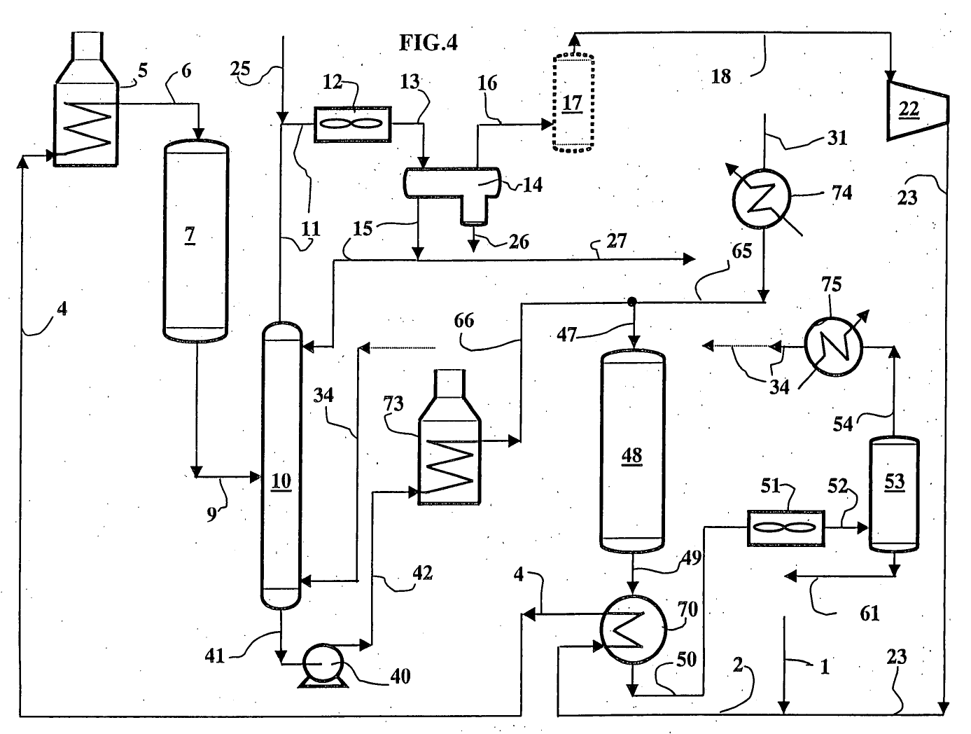

Reference will now be made to FIG. 4.

In this unit, the recycle gas from compressor 22 feeds reaction step a1) alone. The reaction step a3) is supplied with hydrogen exclusively by the makeup hydrogen moving in a single pass in the reaction step a3), i.e. with no recycle. This makeup hydrogen is supplied via line 31, reheated in the heat exchanger 74, then rejoins the stripped reheated liquid effluent via line 65 before being supplied to reactor 48 via line 47. The gaseous effluent from the second reaction step (residual hydrogen from step a3)) moving in line 54 is reheated in the heat exchanger 75 before supplying the column 10 via the line 34 as the stripping gas.

In general, the exchangers (heat exchangers) the second fluid of which is not specified can use any of the other fluids moving in the unit as the second fluid as long as the temperature is adequate. As an example, the hydrogen reheating exchangers 74 and 75 can use the column head effluent or the effluent from step a3) as the heat source.

The other elements shown in FIG. 4 have already been described above with reference to at least one of the preceding figures.

The unit of FIG. 4 can be used if the hydrogen consumption is relatively higher in step a1) than in step a3) and can then ensure sufficient residual gas-cap gas during said second step.

When a noble metal catalyst or a noble metal compound catalyst is used in step a3) in the facilities of FIGS. 1 to 4, in particular FIGS. 2 and 3 in which the recycle gas moves in the two reaction steps in series, the equipment with reference numeral 17 is generally designed to ensure a very low level of impurities in the second reaction step a3).

The equipment with reference numeral 17 can then comprise an amine washer to eliminate H₂S to a residual content of 10 ppm, for example, followed by a drier to eliminate water to a residual content of about 500 ppm, or even 100 ppm or even 10 ppm if the catalyst is highly sensitive to water. The equipment with reference numeral 17 can finally optionally comprise (in the end portion of the equipment) a device for eliminating small residual quantities of H₂S, such as a zinc oxide H₂S capture bed. As an alternative, this bed could also be integrated into reactor 48. The functions that are optionally carried out in equipment 17 (amine wash, partial or total dehydration, elimination of traces of H₂S on a zinc oxide bed) could also be fulfilled in separate equipment not shown in FIGS. 1 to 4.

The facilities described in FIGS. 1 to 4 do not limit the invention. As an example, it would be possible to use the unit of FIG. 2 with a furnace for reheating the stripped liquid effluent (as in the unit of FIG. 3) or, conversely, the unit of FIG. 3 without the furnace for reheating the stripped effluent. The facilities of FIGS. 1 to 4 may also contain no heating furnace either for the effluent from reactor 7 of step a1) which then directly supplies the stripping column 10, nor for the stripped liquid effluent which then directly supplies the reactor 48 of step a3). In certain cases, for example when a catalyst of a noble metal or a noble metal compound functioning at a relatively low temperature is used, it is also possible to have an exchanger for cooling the stripped liquid effluent and not a furnace for reheating said stripped liquid effluent upstream of the reactor 48 in step a3). The scope of the invention also encompasses using limited reheating (for example by at most 90° C. or at most 70° C.) of the effluent from reaction step a1) upstream of the stripping column 10.

The facilities described in FIGS. 2 to 4 and any other unit (optionally with another flowchart) of the invention can also comprise one or more of the devices or equipment described with respect to FIG. 1.

The skilled person will readily be able to conceptualize a unit of the invention comprising:
downstream of the reactor 7 for step a1) and upstream of the stripping column 10: either a cooling exchanger (to cool the effluent from the reactor, preferably by at most 90° C., and highly preferably by at most 70° C., in particular at most 50° C.), or a furnace (to reheat the effluent from the reactor, preferably by at most 90° C., and highly preferably by at most 70° C., in particular by at most 50° C.), or no heat transfer equipment;
downstream of the stripping column 10 and upstream of the reactor 48 of step a3): either a cooling exchanger (to cool the stripped liquid effluent, preferably by at most 90° C., more preferably by at most 70° C. and especially by at most 50° C.) or a furnace (to reheat the effluent from the reactor, preferably by at most about 90° C., highly preferably by at most 70° C., in particular by at most 50° C.) or no heat transfer equipment, the stripped liquid effluent then directly supplying the second hydrotreatment reactor 48 after adding a stream of hydrogen (preferably heated), for example heated recycle hydrogen;
at the stripping column 10, it is optionally possible to use a reboiler for the liquid from the column bottom (not shown in FIGS. 1 to 4), for example to maintain the column bottom temperature in the range 255° C. to 390° C. and preferably between about 305° C. and 390° C.

For the facilities described in this application, and more generally regardless of the flow chart of the unit, the skilled person can also use other heat exchanges between a plurality of streams moving in the unit, as a function of the respective temperatures of said different streams.

The skilled person could also readily conceptualize a unit of the invention functioning with another hydrotreatment unit diagram in two or more (for example three) hydrotreatment steps. The method of the invention can in particular be used in a unit obtained by modifying one of the facilities described in the prior art or in one of the patents cited in said application (and comprising hydrogen stripping between a first hydrotreatment step and a second hydrotreatment step) by:
adding to the stripping column a rectification section having a sufficient number of theoretical plates supplied via a substantially desulphurized liquid reflux stream;
preferably adding a direct evacuation line 27 downstream of a portion of the substantially desulphurized light hydrocarbon liquid fraction;
optional addition or optional subtraction or optional modification (to reduce the power) of a reheating furnace (or exchanger) or of a cooling exchanger, located either downstream of the reactor 7 for step a1) and upstream of the stripping column 10 or downstream of the stripping column 10 and upstream of the reactor 48 for step a3).

As an example, the unit can comprise a single hydrogen recycle loop with, downstream of the recycle compressor, a division of the recycle gas circulation line into in particular two lines separately and in parallel supplying the reactors for the two hydrotreatment steps a1) and a3), also preferably comprising a purification device (H₂S elimination, and optionally water elimination) processing the hydrogen stream(s) recycled to step a3) (upstream of the reactor and between the catalytic beds) and optionally a supply of stripping gas from purified recycle hydrogen.

A unit of the invention can also comprise gas/liquid separation for the effluent from the first reaction zone a1) (downstream of the reactor 7), the stripping column only being supplied with liquid from said separator. In this case, the effluent from the reactor 7 is preferably cooled to a relatively low temperature (for example less than about 120° C. and for example to about 50° C.). The gas from said relatively cold separator can then undergo rectification, or it might not be rectified therein.

However, in accordance with the invention, it is preferable to supply the column with all of the effluent from the first reaction zone a1).

In general, a unit for hydrotreatment of a hydrocarbon feed in accordance with the invention comprises:
a first hydrotreatment reaction section comprising at least one first hydrotreatment reactor 7;
a stripping section comprising a pressurized stripping column 10 connected upstream to the first reactor 7 to strip the effluent from said reactor using a hydrogen-rich gas, in which the head of the column 10 is connected to a means 12 for cooling and partially condensing the gaseous stream from the column 10, said cooling means being connected downstream to at least one stripping step gas/liquid separator 14;
a second hydrotreatment reaction section comprising at least one second hydrotreatment reactor 48 connected upstream to the bottom of the stripping column 10 to hydrotreat the stripped liquid effluent issuing from the bottom of said stripping column 10, and connected downstream to a second reaction step gas/liquid separator 53;
   said stripping column 10 comprising, above the supply for the effluent from the first reactor 7, a rectification zone having a separation efficiency of at least 1 theoretical plate, the upper portion of said zone being connected to a line 15 for supplying a substantially desulphurized liquid reflux.

Preferably, the unit also comprises a line 27 for direct downstream evacuation of a light hydrocarbon liquid fraction removed from said stripping step gas/liquid separator 14, said evacuation line being connected upstream to said stripping step gas/liquid separator 14.

Preferably, the rectification zone is a column section with an efficiency corresponding to 2 to 20 theoretical plates, in particular 5 to 14 theoretical plates. In addition to the stripping section of the stripping column (stripping the liquid falling below the supply), it can comprise plates, for example perforated plates, and/or packing elements (for example Pall or Raschig rings, which are well known to the skilled person), or other equivalent technical means having a fractionation efficiency.

The unit often comprises a line 15 for supplying a substantially desulphurized liquid reflux connected upstream to the stripping step gas/liquid separator 14. It can also comprise a line for supplying a substantially desulphurized liquid reflux connected upstream to the gas/second reaction step liquid separator 53. In a further variation, the column head 10 is connected to the stripping step gas/liquid separator 14 via at least one connecting line 11, 13, said connecting line being connected to the second reaction step gas/liquid separator 53, for example to allow contact of the gaseous effluent from the column head by all or part of the hydrotreated liquid fraction. As an alternative, the (total) effluent from step a3) can also be recovered and mixed with the effluent from the head of the stripping column. In this case, the stripping step gas/liquid separator and the second reaction step gas/liquid separator are the same equipment (common). Often the equipment is separate, however.

The means 12 for cooling and partially condensing the effluent from the stripping column head can comprise one or more heat exchangers of any type (or several types) that are known to the skilled person, a non limiting example being one or more tube exchangers and/or plate exchangers in series to carry out heat exchange with one or more other colder streams, optionally followed by an air-cooled exchanger and/or a water cooler.

The effluent from the column head can optionally be cooled in a plurality, in particular two steps, with initial cooling followed by gas/liquid separation in a first stripping step gas/liquid separator and second cooling of the gas from said first separator being followed by a second gas/liquid separation in a second stripping step gas/liquid separator. The first separation can optionally provide a substantially desulphurized liquid reflux (all of the condensed liquid optionally being used as reflux) and the second separation can optionally provide a light hydrocarbon liquid fraction evacuated directly downstream. It is also possible to carry out contact of the stream moving upstream of the first stripping step gas/liquid separator and/or, as is preferable, the stream moving upstream of the second stripping step gas/liquid separator (the gaseous effluent from the first separator) with all or part of the hydrotreated liquid fraction. Injection of the washing water, optional but preferred, can also be carried out upstream of any or each of these gas/liquid separators.

In one preferred variation of the unit of the invention, the first hydrotreatment reactor 7 is connected directly downstream to a limited cooling means 3 for the effluent from said reactor, with a cooling capacity corresponding to at most 90° C., and preferably at most 70° C., and in particular at most 50° C. (cooling of said effluent) and this limited cooling means 3 is directly connected downstream to the stripping column 10. The term “directly” means that there is no intermediate heat exchange, connection being made by a simple line.

The limited cooling means is generally a heat exchanger (of any type, for example a tube exchanger or plate exchanger) exchanging heat with another, cooler stream moving in the unit, for example the feed for step a1) or another cooling fluid; it can also be constituted by a plurality of exchangers in series and/or in parallel. It is also possible to use limited cooling by mixing the effluent from the hydrotreatment reactor 7 with a cooler liquid stream, in particular a portion of the light hydrocarbon liquid fraction (typically recovered at the stripping step gas/liquid separator), the limited cooling means then comprising a line for supplying a cooler liquid stream. The limited cooling can be controlled and/or can vary with time, for example to maintain a constant supply temperature to the stripping column, while the temperature 7 at the reactor outlet increases slightly with time to compensate for the reduction in catalytic activity over-time (in particular due to ageing and/or coking of the catalyst).

The supply temperature for the stripping column can, for example, be controlled by varying the flow rate of the cooling fluid (indirectly or by mixing) using appropriate means, and/or by partial bypass of the limited cooling means.

In a further preferred variation of the unit of the invention, the first hydrotreatment reactor 7 is directly connected downstream to the stripping column 10. Thus, there is no intermediate heat exchange equipment between this reactor and the column.

### EXAMPLES

The following examples provide non limiting explanations of the operating conditions used in the process of the invention:

### Example 1

Feed treated: straight run gas oil with the following characteristics:

distillation interval (5%-95% distilled): 210-370° C.;

density: 0.85;

sulphur content: 10000 ppm;

cetane index: 48

Operating Conditions in First Step a1):

catalyst: HR416 Co—Mo on alumina catalyst sold by AXENS (formerly PROCATALYSE);

reactor outlet temperature: 350° C.;

reactor outlet pressure: 4.2 MPa;

H₂ partial pressure, reactor outlet: 2.5 MPa;

HSV (hourly space velocity): 2.0 h⁻¹;

hydrogen (reactor inlet+quench): 200 Nm³/m³ of feed;

hydrogen consumed in step a1): 0.5% by weight with respect to feed;

Operating Conditions in Step a2):

stripping column inlet temperature: 320° C.;

stripping column inlet pressure: 4.0 MPa;

number of theoretical plates above supply: 9;

number of theoretical plates below supply: 15

nature of reflux: portion of light hydrocarbon liquid fraction (sulphur content 8 ppm);

reflux ratio with respect to hydrocarbon feed for column: 0.33 kg/kg/;

stripping hydrogen: flow rate corresponding to 95% of hydrogen consumed in first step;

temperature at bottom of stripping column: 315° C.;

quantity of light hydrocarbon liquid fraction removed: about 30% by weight with respect to initial feed;

flow rate of stripped liquid effluent: about 70% by weight of initial feed.

Operating Conditions for Second Reaction Step a3):

catalyst: HR 448 catalyst, Ni—Mo on alumina sold by AXENS (formerly PROCATALYSE);

reactor inlet temperature: 315° C.;

reactor outlet temperature: 335° C.;

reactor outlet pressure: 4.9 MPa;

HSV: 1.5 h¹;

hydrogen (inlet+quench): 350 Nm³/m³ of feed for step a3);

the following results were obtained for this two-step hydrotreatment:

sulphur content (organic, i.e. ex-H₂S) of the liquid fraction of the total effluent from step a1): about 250 ppm;

sulphur content of light hydrocarbon liquid fraction removed (representing 30% by weight of the initial feed): 8 ppm;

sulphur content in stripped liquid effluent: about 355 ppm;

sulphur content in hydrotreated liquid fraction: 8 ppm;

sulphur content in total reconstituted liquid effluent: hydrotreated liquid fraction+light hydrocarbon liquid fraction takeoff: 8 ppm;

cetane index of total reconstituted liquid (stabilized): 51.

### Example 2

The feed, first reaction step a1), and stripping step a2) were identical to Example 1. Example 2 differs from Example 1 in using in the reaction step a3) a noble metal platinum/palladium on alumina type catalyst.

Operating Conditions for Second Reaction Step a3):

Catalyst: platinum/palladium on alumina, containing, as a % by weight:

0.23% of platinum; 0.84% of palladium; 1.13% of chorine; 4.20% of fluorine.

reactor inlet temperature: 315° C.;

reactor outlet temperature: 335° C.;

reactor outlet pressure: 4.9 MPa;

HSV: 4.3 h⁻¹;

hydrogen (inlet+quench): 350 Nm³ μm³ of feed for step a3);

the following results were obtained for this hydrotreatment of step a3) of Example 2:

sulphur content of the hydrotreated liquid fraction: 8 ppm;

sulphur content of total reconstituted liquid effluent: hydrotreated liquid fraction+light hydrocarbon liquid fraction takeoff: 8 ppm;

cetane index of total reconstituted liquid (stabilized): 56.

The feed was desulphurized to the same final content in Examples 1 and 2. The unit of Example 2, using a noble metal platinum/palladium on alumina type catalyst in step a3), had the great advantage of using a much higher hourly space velocity (and thus reduced dimension reactor) and of gaining 5 points in the cetane index. However, the catalyst was more expensive.

In the two cases, the reactor from the second step had a substantially reduced catalytic volume with respect to a unit with no production of a light hydrocarbon liquid fraction that is substantially desulphurized (to 8 ppm) because of the reduced feed supplied to step a3).

Further, energy integration was higher and there was no major cooling/reheating upstream/downstream of the stripping column, which also minimized the required surface areas of the heat exchangers.

For a variety of feeds and product specifications, then, the process of the invention can more efficiently eliminate all of the pollutants present in a first hydrotreatment step and use in an optimum manner the best catalysts available for the second step, with a second step reactor of reduced size, with a high energy efficiency without requiring intermediate distillation.

1. A process for hydrotreating a hydrocarbon feed containing sulphur-containing compounds, comprising the following steps:
a first step a1) for hydrotreatment in which said feed and excess hydrogen are passed over a first hydrotreatment catalyst to convert at least the major portion of the sulphur contained in the feed into H₂S;
downstream of step a1), a step a2) for stripping the partially desulphurized feed from step a1) in a pressurized stripping column using at least one hydrogen-rich stripping gas, to produce at least one gaseous effluent at the column head and at least one stripped liquid effluent, said gaseous effluent at the column head being cooled and partially condensed, then separated in at least one stripping step gas/liquid separator, into at least one light hydrocarbon liquid fraction and a gaseous stripping step effluent;
downstream of step a2), a second hydrotreatment step a3) in which the stripped liquid effluent and excess hydrogen are passed over a second hydrotreatment catalyst;
in which:
in an upper portion of the stripping column located above the supply to said column, a step for rectification of stripping vapours rising above the supply is carried out using a liquid reflux with a sulphur content of less than about 50 ppm;
at least a portion of said light hydrocarbon liquid fraction is taken off and evacuated directly downstream;
the following parameters are selected: the temperature of the supply to the stripping column, the stripping gas flow rate, and the liquid reflux flow rate, so that the stripped liquid effluent represents at most 90% by weight of the feed supplied to step a1), and in combination with said parameters the degree of desulphurization of step a1) is determined along with the efficiency of separation of the rectification step, such that the sulphur content in said light hydrocarbon liquid fraction is less than about 50 ppm.

2. A process according to claim 1, in which the effluent from step a3) is cooled then separated in a second reaction step gas/liquid separator, into a hydrotreated liquid fraction and a gaseous effluent from the second reaction step.

3. A process according to claim 1, in which said liquid reflux comprises a fraction of said light hydrocarbon liquid fraction.

4. A process according to claim 1, in which said liquid reflux comprises a fraction of said hydrotreated liquid fraction.

5. A process according to claim 1, in which the rectification step is carried out in a rectification zone with a separation efficiency in the range 1 to 30 theoretical plates, limits included.

6. A process according to claim 1, in which said gaseous effluent from the column head is cooled and partially condensed then separated in a stripping step gas/liquid separator into a light hydrocarbon liquid fraction and a gaseous stripping step effluent, and in which a portion of said light hydrocarbon liquid fraction is removed and evacuated directly downstream, the complementary portion of said light hydrocarbon liquid fraction takeoff being returned in its entirety to the stripping column, directly or after optional heat exchange carried out on all or a portion of said complementary portion, at least a fraction of said complementary portion constituting the liquid reflux for said column.

7. A process according to claim 1, in which the light hydrocarbon liquid fraction takeoff represents at least 20% by weight of the feed for step a1), and the stripped liquid effluent represents at most 80% by weight of the feed for step a1).

8. A process according to claim 1, in which the effluent from hydrotreatment step a1) is supplied to the fractionation column with a possible temperature difference of at most 90° C. with the outlet temperature from the reaction step a1).

9. A process according to claim 8, in which the effluent from the hydrotreatment step a1) is supplied to the fractionation column after limited cooling of at most 90° C.

10. A process according to claim 8, in which the effluent from the hydrotreatment step a1) is supplied directly to the fractionation column at a temperature substantially identical to the temperature at the outlet from the reaction step a1).

11. A process according to claim 1, in which the effluent from the hydrotreatment step a1) is supplied to the fractionation column at a temperature in the range from about 255° C. to about 390° C.

12. A process according to claim 2, in which the second hydrotreatment step a3) is carried out in the presence of excess hydrogen constituted by makeup hydrogen moving in a single pass, and said gaseous effluent from the second reaction step is recycled to step a1).

13. A hydrocarbon cut from the group formed by gasoline, jet fuel, kerosene, diesel fuel, gas oil, vacuum distillate and deasphalted oil, containing at least one fraction hydrotreated by the process according to claim 1.

14. A unit for hydrotreatment of a hydrocarbon feed, comprising:
a first hydrotreatment reaction section comprising at least one first hydrotreatment reactor 7;
a stripping section comprising a pressurized stripping column 10 connected upstream to the first reactor 7 to strip the effluent from said reactor using a hydrogen-rich gas, in which the head of the column 10 is connected to a means 12 for cooling and partially condensing the gaseous stream from the column 10, said cooling means being connected downstream to at least one stripping step gas/liquid separator 14;
a second hydrotreatment reaction section comprising at least one second hydrotreatment reactor 48 connected upstream to the bottom of the stripping column 10 to hydrotreat the stripped liquid effluent issuing from the bottom of said stripping column 10, and connected downstream to a second reaction step gas/liquid separator 53;
said stripping column 10 comprising, above the supply for the effluent from the first reactor 7, a rectification zone having a separation efficiency of at least 1 theoretical plate, the upper portion of said zone being connected to a line 15 for supplying a substantially desulphurized liquid reflux.

15. A unit according to claim 14, also comprising a line 27 for direct downstream evacuation of a light hydrocarbon liquid fraction removed from said stripping step gas/liquid separator 14, said evacuation line being connected upstream of said stripping step gas/liquid separator 14.

16. A unit according to claim 14, in which said line for supplying a substantially desulphurized liquid reflux is connected upstream of the stripping step gas/liquid separator 14.

17. A unit according to claim 14, in which the line for supplying a substantially desulphurized liquid reflux is connected upstream of the second reaction step gas/liquid separator 53.

18. A unit according to claim 14, in which the column head 10 is connected to the stripping step gas/liquid separator 14 via at least one connecting line 11, 13, said connecting line being connected to the second reaction step gas/liquid separator 53.

19. A unit according to claim 14, in which the first hydrotreatment reactor 7 is directly connected to the stripping column 10 downstream.

20. A unit according to claim 14, in which the first hydrotreatment reactor 7 is directly connected downstream to a limited cooling means 3 with a cooling capacity of at most 90° C., said limited cooling means being directly connected to the stripping column 10 downstream.
